(19) United States
(12) Patent Application Publication
(10) Pub. No.: US 2016/0165223 A1
(43) Pub. Date: Jun. 9, 2016

(54) LIGHT-RESTRICTED PROJECTION UNITS AND THREE-DIMENSIONAL DISPLAY SYSTEMS USING THE SAME

(71) Applicant: Sun Yat-sen University, Guangdong (CN)

(72) Inventors: Lilin LIU, Guangdong (CN); Dongdong TENG, Guangdong (CN)

(21) Appl. No.: 14/825,854

(22) Filed: Aug. 13, 2015

(30) Foreign Application Priority Data
Dec. 8, 2014 (CN) 201410739057.3

(51) Int. Cl. H04N 13/04

(52) U.S. Cl. CPC H04N 13/0459; H04N 13/0447

(57) ABSTRACT

The invention features a multi-view display system based on planar- or circular-aligned light-restricted projection units. A light-restricted projection unit is constituted by a display panel, a directional imaging structure transmitting optical messages from the display panel along a specific direction, and baffles encasing the display panel/directional imaging structure pair for light blocking. During operation, all the light-restricted projection units project images to a common display zone. Each light-restricted projection unit generates two kinds of zones: VZ where light rays from all pixels of the display panel pass and PVZ where light rays from partial pixels of the display panel pass. With the light-restricted projection units being aligned closely, PVZs from different light-restricted projection units completely or partially overlap into a fusing zone (FZ). For each point in the FZ, light rays from pixels belonging to segments of different display panels pass. The spatial percents of different segments occupying their display panels change with the point location, resulting in changing views presented to the pupil moving from one VZ (or image area of one VZ) to its adjacent VZ (or image area of the adjacent VZ). With the help of these keeping-changed views, continuous motion parallax gets implemented. Furthermore, through introducing sequentially gated gating-apertures, perspective views corresponding to more viewpoints can be presented by the display system based on persistence of vision for better three-dimensional effects.

### THECHNICAL FIELD

This invention relates to three-dimensional displays, and more particularly to multi-view display techniques.

### BACKGROUND

A multi-view display system projects perspective views to multiple viewpoints through special optical structures. A pupil arriving at each viewpoint can perceive the corresponding perspective view, which makes the viewer perceive different perspective view pairs as his/her left and right eyes move into different viewing zones around the corresponding viewpoints. Thus, the multi-view display system evokes both stereo parallax and motion parallax depth cues of the viewers. This three-dimensional display technology is compatible with existing two-dimensional display panels. So, the multi-view display technology is developing very rapidly in recent years and begins to occupy a prominent position in the three-dimensional display field. Inherently, due to very limited numbers of perspective views provided by the display system, the perspective view perceived by a pupil will not change until the pupil moves into the viewing zone of the adjacent viewpoint. The motion parallax thus appears in a stepwise fashion, which degrades the effectiveness of three-dimensional displays.

### SUMMARY OF THE INVENTION

The invention features methods and systems for producing three-dimensional images with continuous motion parallax. We propose new multi-view display systems, which overcome the stepwise fashion in motion parallax by transitional views tiled up by segments of different perspective views or by dense perspective views with very small angular separations.

In general, in one aspect, the invention features new multi-view display systems. Embodiments of the display system comprise closed aligned. light-restricted projection units and an optional Accessorial Lens. Each light-restricted projection unit is constituted by a display panel for displaying optical images, a directional imaging structure for transmitting optical messages from the display panel along a specific direction, and baffles encasing the display panel/directional imaging structure pair for light blocking.

Each pixel of the display panel has a diverging angle large enough to cover the whole directional imaging structure; during operation, display panels are imaged to a common display zone through the corresponding directional imaging structure or the combination of the corresponding directional imaging structure and the Accessorial Lens; with partial light rays blocked by corresponding baffles, each light-restricted projection unit generates two types of zones: VZ where light rays from all pixels of the display panel pass and PVZ where only light rays from partial pixels of the display panel pass; PVZs from adjacent light-restricted projection units completely or partially overlap into a fusing zone (FZ). For each point in the FZ, light rays from pixels belonging to segments of different display panels pass.

Embodiments of the display systems may include any of the following features.

The display panel may be an OLED display, or a LED display, or a liquid crystal display, or a Digital Light Processing (DMD).

The directional imaging structure may be a lens or a group of optical elements functioning as a lens.

The directional imaging structure may also be a lens-prism pair.

The directional imaging structure may be diffraction gratings, or a diffraction grating-lens pair.

The system may further include a Field Lens to image the VZs and FZs.

The system may additionally include a diffuser to enlarge the scattering angle of the incident light.

The system may also include a gating-apertures array whose gating-apertures can be gated sequentially.

In general, in another aspect, the invention includes methods of producing three-dimensional images based on the multi-view technology. The method includes: (i) projecting the perspective view which converges to a point from one display panel or segments of different display panels through the corresponding directional imaging structure; (ii) presenting perspective views which converge to different points simultaneously.

In the method, a perspective view may be projected from a display panel or segments of different display panels through the corresponding directional imaging structures and an Accessorial Lens.

In the method, a perspective view may be projected from a display panel or segments of different display panels through the corresponding directional imaging structures and a Field Lens

In the method, a perspective view may be projected from a display panel or segments of different display panels through the corresponding directional imaging structures, an Accessorial Lens and a Field Lens.

A further method may include: (i) inserting a gating-aperture array into the VZ-FZ zone which includes all the VZs and FZs; (ii) with a gating-aperture being gated, sub-images projected from one or more display panels through the corresponding optical structure get presented to different points, each such sub-image is set to carry the content of the perspective view converging to the corresponding point or a point near the corresponding point; (iii) gating a group of gating-apertures at one time point, with all display panels refreshed for generating corresponding sub-images; (iv) gating different groups of gating-apertures sequentially and cyclically, with all display panels refreshed synchronously for generating corresponding sub-images.

In the method, a gating-aperture array may be inserted into the image area of the VZ-FZ zone which includes all the VZs and FZs.

A further method may include: (i) inserting a gating-apertures array into the VZ-FZ zone which includes all the VZs and FZs; (ii) with a gating-aperture being gated, a perspective view converging to a point on or near this gating-aperture or its image is taken as the target image being projected from one or more display panels through the corresponding optical structure; (iii) gating a group of gating-apertures at one time point, with all display panels refreshed for generating corresponding target images; (iv) gating different groups of gating-apertures sequentially and cyclically, with all display panels refreshed synchronously for generating corresponding target images.

In the method, when a gating-aperture is gated, the perspective view converging to a point on or near this gating-aperture's image area is taken as the target image projected from one or more display panels through the corresponding optical structure.

In the method, a gating-aperture array may be inserted into the image area of the VZ-FZ zone which includes all the VZs and FZs

The details of one or more embodiments of the invention are set forth in the accompanying drawings and description below. Other features, objects, and advantages of the invention will be apparent from the description, drawings, and claims.

### BRIEF DESCRIPTION OF THE DRAWINGS

FIG. 1 is an embodiment of a multi-view display system with planar-aligned light-restricted projection units which project virtual images.

FIG. 2 is an embodiment of a multi-view display system with circular-aligned light-restricted projection units which project virtual images.

FIG. 3 is an embodiment of a multi-view display system with a prism-lens pair as the directional imaging structure.

FIG. 4 is an embodiment of a multi-view display system with planar-aligned light-restricted projection units which project real images.

FIG. 5 is an embodiment of a multi-view display system with circular-aligned light-restricted projection units which project real images.

FIG. 6 is an embodiment of a multi-view display system with planar-aligned light-restricted projection units which project images to infinity.

FIG. 7 shows the theory of time-multiplexing based on seamlessly aligned clear apertures for a multi-view display system with planar-aligned light-restricted projection units.

FIG. 8 shows an available position for seamlessly aligned clear apertures in a multi-view display system with planar-aligned light-restricted projection units.

FIG. 9 shows available positions for seamlessly aligned clear apertures in a multi-view display system with circular-aligned light-restricted projection units.

FIG. 10 is an embodiment of a time-multiplexing multi-view display system with orthogonal views being projected.

### DETAILED DESCRIPTION OF THE INVENTION

Multi-view three dimensional display systems that embody the invention depend on the light-restricted projection unit, which generates two types of zones: VZ where light rays from all pixels of the display panel pass, and PVZ where only light rays from partial pixels of the display panel pass. With such light-restricted projection units planar- or circular-aligned closely, PVZs from adjacent light-restricted projection units overlap into a fusing zone (FZ). For each point in the FZ, light rays from pixels belonging to segments of different light-restricted display panels pass. All the FZs and VZs, or their image areas, connect together to construct a viewing region. In a VZ-related zone of the viewing region, the observed view is projected from a display panel. Differently, at an observation point in the FZ-related zone of the viewing region, the observed view is a splice image, which is tiled by segments projected from different display panels. This kind of splice images is called transitional views in this application. The spatial percents of different segments tiling up the transitional view vary with the position of the observation point. So, as a pupil moves from a VZ-related zone to its adjacent VZ-related zone, the observed transitional view keeps changing and thus results in a continuous motion parallax. Furthermore, through inserting gating-apertures array into the VZ-FZ zone or its image area, time-multiplexing can be introduced into the invention. At a time point, a group of gating-apertures, which have such characteristics that light rays passing through them come from different segments of all the display panels, are gated with all display panels refreshed by corresponding messages. Then, with different groups of gating-apertures gated sequentially and cyclically, a multi-view display system which projects perspective views to more viewing points gets implemented based on persistence of vision.

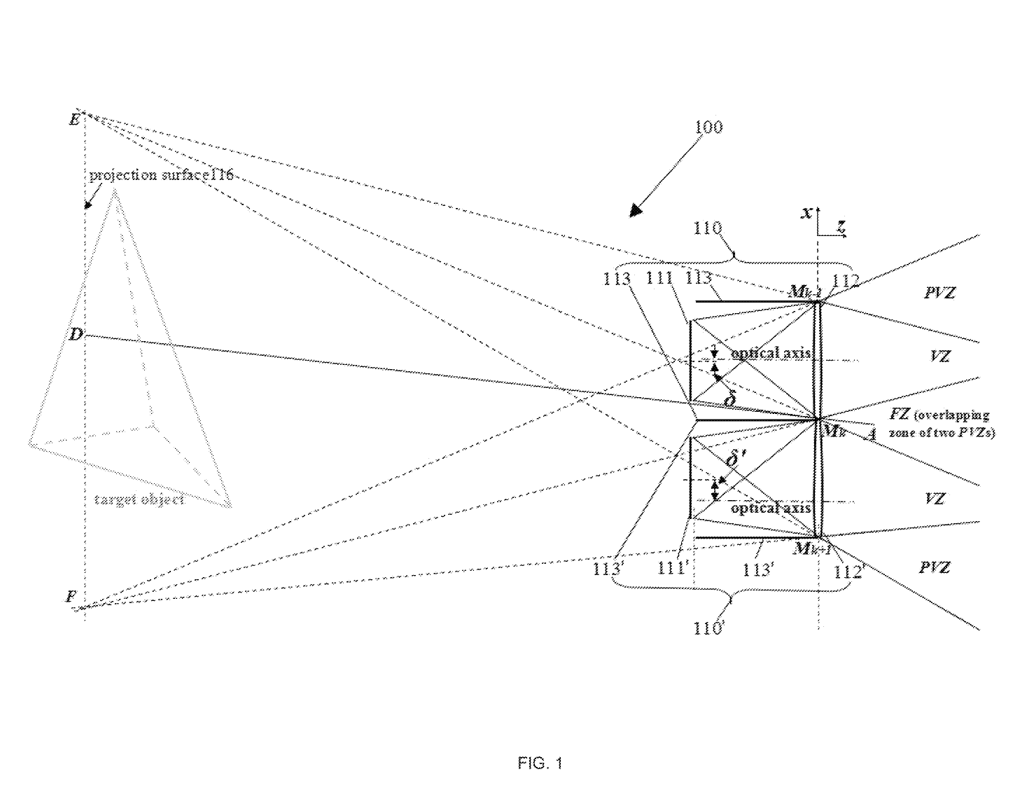

FIG. 1 shows an embodiment of a multi-view display system 100 with planar-aligned light-restricted projection units which project virtual images. Here, only two light-restricted projection units 110 and 110′ are drawn for simplicity, which are constituted by display panels 111 and 111′, lenses 112 and 112′ which function as the directional imaging structure, and baffles 113 and 113′, respectively. The lenses 112 and 112′ connect together at the point Mₖ. Optical axises of the lenses 112 and 112′ take specific offset values with respect to the corresponding display panels 111 and 111′, guaranteeing the virtual images of the two display panels 111 and 111′ overlap into the common EF zone on the projection surface 116.

When only the display panel 111 is activated, the loaded message is projected to the EF zone through the directional imaging lens 112. Due to usage of the baffles 113, partial light rays from the display panel 111 which exceed the directional imaging lens 112 get blocked. According to geometric optics, the passing light rays form two types of zones: a VZ and two PVZs For points in the VZ, the whole virtual image of the display panel 111 is visible. But for an observation point in the PVZ, only partial virtual image of the display panel 111 is visible. Similarly, above process is applicable to other light-restricted projection units. According to the geometrical structure shown in FIG. 1, two PVZs from light-restricted projection units 110 and 110′ overlap to construct a fusing zone (FZ).

Then, display panels 111 and 111′ are activated simultaneously to project two perspective views of the target object. The viewpoint of each perspective view may be any points within the corresponding VZ. For an observation point A in the FZ, the ED segment of the perspective view projected from the display panel 111 and the DF segment of the perspective view projected from the display panel 111′ get visible. The two segments link up at the point D seamlessly, spatially tiling up a transitional view. The joint point D of the two segments is in fact an intersection point of the line AMₖ with the projection surface 116, which performs linkage movement with the observation point. That is to say, for an observation point moving across the FZ zone, the spatial ratio of the two observed segments from different perspective views changes from 1:0 to 0:1 gradually.

When more light-restricted projection units are involved, more VZs and FZs will connect together to construct a larger viewing region.

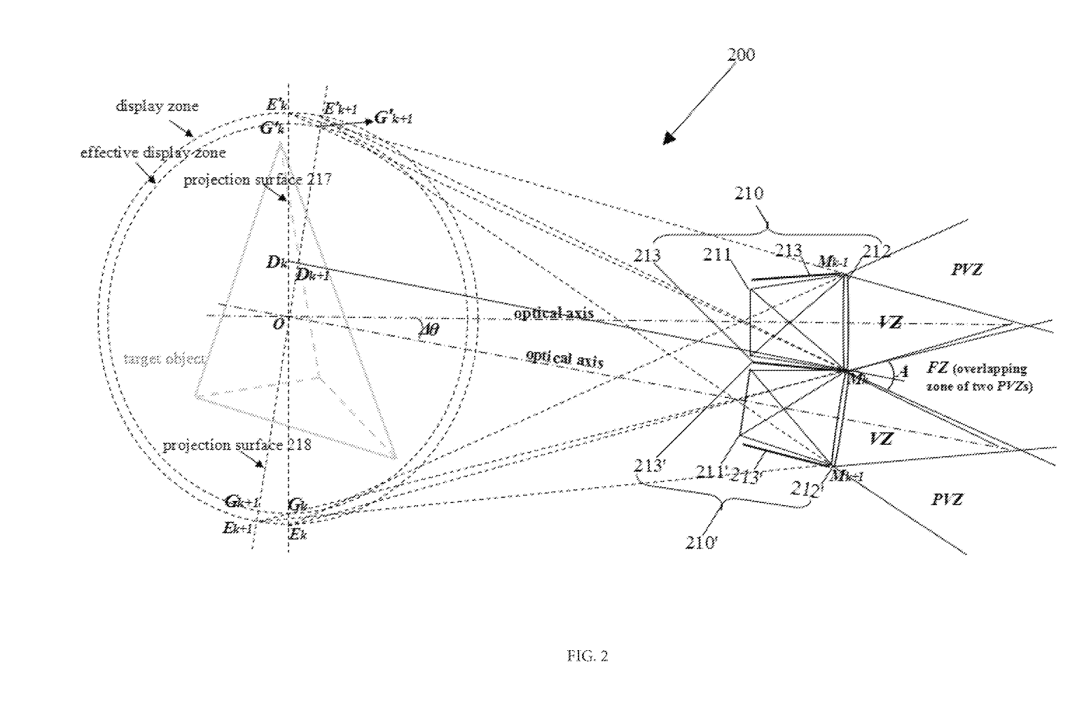

FIG. 2 shows an embodiment of a multi-view display system 200 with circular-aligned light-restricted projection units which project virtual images. Here, only two projection units 210 and 210′ are drawn for simplicity, which are constituted by display panels 211 and 211′, lenses 212 and 212′ which function as the directional imaging structure, and baffles 213 and 213′, respectively. The directional imaging lenses 212 and 212° connect at point Mₖ with a relative inclination angle of Δθ. Optical axises of the directional imaging lenses 212 and 212′ pass through the geometrical centers of their corresponding display panels 211 and 211′. Virtual images of the two display panels 211 and 211′ are projected to the EₖE′ₖ zone of the projection surface 217 and the Eₖ₊₁E′ₖ₊₁ zone of the projection surface 218, respectively. The EₖE′ₖ zone and the Eₖ₊₁E′ₖ₊₁ zone co-exist in the common display zone centered at the point O.

When only the display panel 211 is activated, the loaded message is projected to the EₖE′ₖ zone through the directional imaging lens 212. Due to the usage of baffles 113, partial light rays from the display panel 211 which exceed the directional imaging lens 212 are blocked. According to the geometric optics, the passing light rays form two types of zones: a VZ and two PVZs. For points in the VZ, the whole image of display panel 211 is visible. But for a point in the PVZ, only partial image of display panel 211 is visible. Similarly, above process is applicable to other light-restricted projection units. According to the geometrical structure shown in FIG. 2, two PVZs from projection units 210 and 210′ partially overlap to construct a fusing zone (FZ).

Then, display panels 211 and 211′ are activated simultaneously to project two perspective views of the target object. The two perspective views converge to points belonging to two different VZ zones, respectively. For an observation point A in the FZ, the E′ₖDₖ segment of the perspective view projected from the display panel 211 and the Dₖ₊₁Eₖ₊₁ segment of the perspective view projected from the display panel 211′ get visible. The two segments link up along the viewing direction, spatially tiling up a transitional view. The points Dₖ and Dₖ₊₁ are on the viewing direction AMₖ, which performs linkage rotation with the observation point around the point Mₖ. That is to say, as an observation point moves across the FZ zone, the spatial ratio of the observed two segments from different perspective views changes from. 1:0 to 0:1 gradually. Consequently, a continuously changing transitional view gets realized for a moving observation point. Between the adjacent VZ and PZ, a residual part of PVZ remains non-overlapping. If Δθ is not too large, the residual partial PVZ may be covered by a pupil and the pupil can still perceive all the projected messages from the corresponding display panels 210 or 210′. Another method is to shrink the display zone to an effective display zone determined by Gₖ, G′ₖ, Gₖ₊₁ and G′ₖ₊₁. With G′ₖ₊₁ as an example, it is an intersection point of the line Mₖ₊₁E′ₖ with the projection surface 218.

With more light-restricted projection units circularly aligned, more VZs, residual partial PVZs and FZs will connect together to construct a larger viewing region. In the embodiment, the directional imaging lenses 212 (212′) can be replaced with a prism-lens pair.

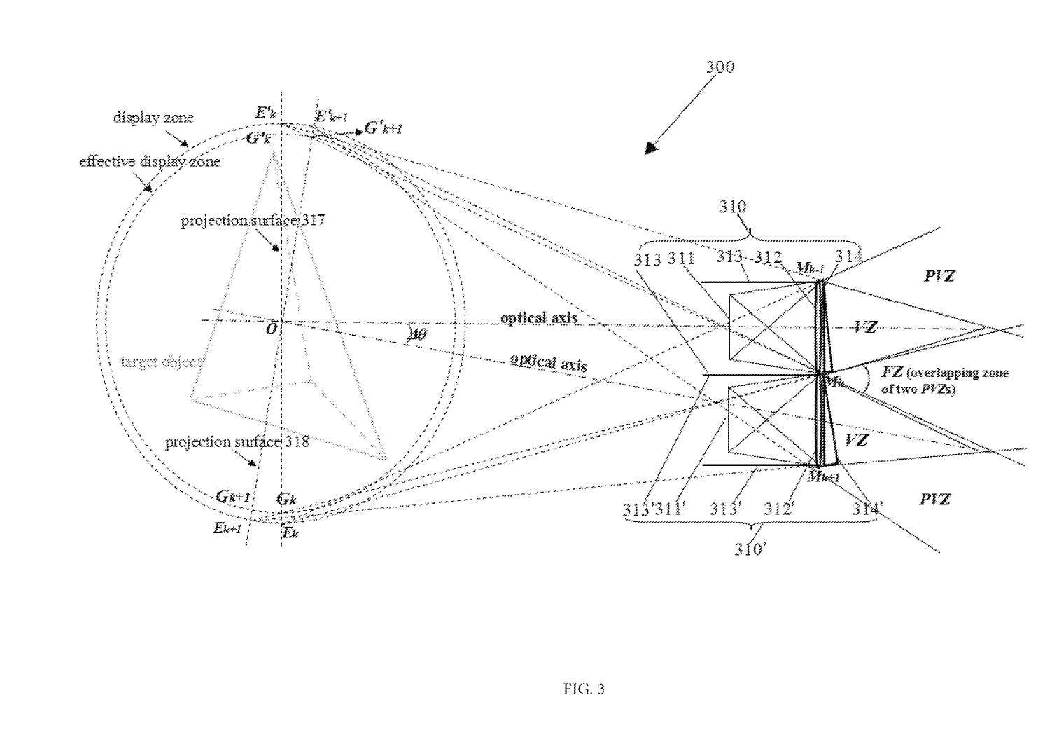

FIG. 3 is an embodiment with a prism 314-lens 312 pair (or prism 314′-lens 312′ pair) to replace the lens 212 (or lens 212′) of FIG. 2. In this case, the projection surfaces 317 and 318 meet at the point O with a rotation angle, similar to FIG. 3. Here, due to the existence of prisms 314 and 314′, the projection surfaces 317 and 318 may not be strictly flat plane.

When the light-restricted projection units project real images, the SV-FZ zone which includes all SVs and FZs needs to be imaged as the viewing region.

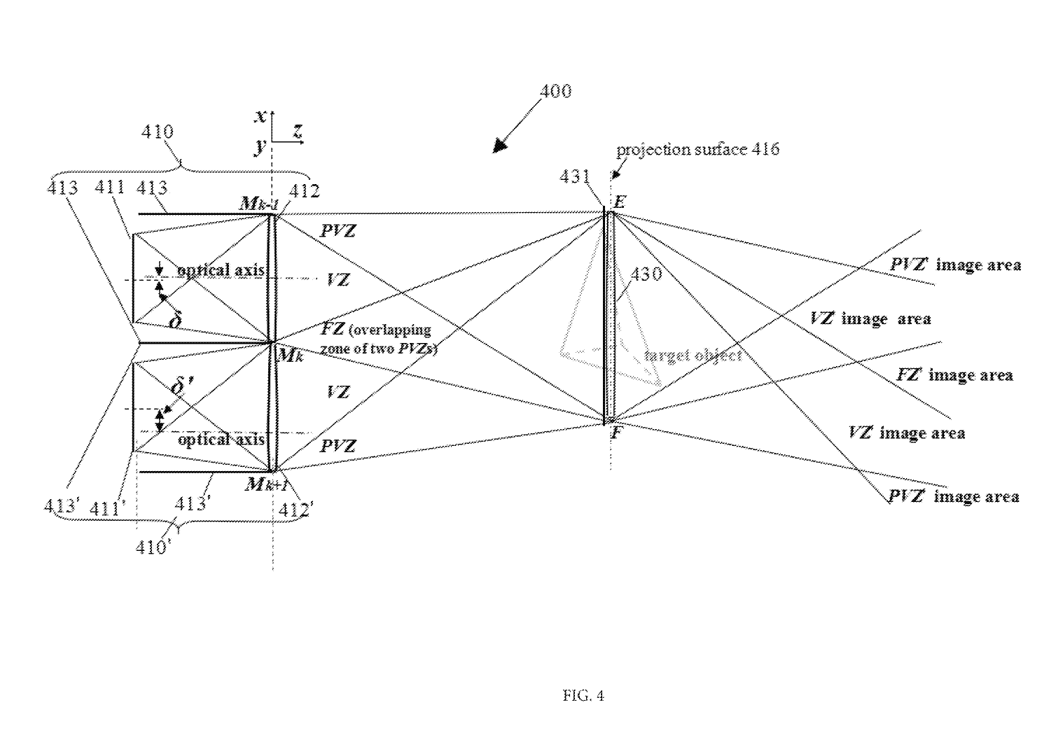

FIG. 4 shows an embodiment of a multi-view display 400 with planar-aligned light-restricted projection units which project real images. Here, only two light-restricted projection units 410 and 410′ are drawn for simplicity, which are constituted by display panels 411 and 411′, lenses 412 and 412′ which function as directional imaging structure, and baffles 413 and 413′, respectively. The directional imaging lenses 412 and 412′ connect at the point Mₖ. Optical axises of the directional imaging lenses 412 and 412′ take specific offset values with respect to the corresponding display panels 411 and 411′, thus guaranteeing the real images of the two display panels 411 and 411′ overlap into the common EF zone on the projection surface 416. A Field lens 430 locates on the projection surface 416.

When only the display panel 411 is activated, the loaded messages are projected to the EF zone through the directional imaging lens 412. Due to the usage of baffles 413, partial light rays from the display panel 411 which exceed the directional imaging lens 412 are blocked. According to the geometric optics, the passing light rays form two types of zones: a VZ and two PVZ. For points in the VZ, light rays from all pixels of the display panel 411 pass. But for a point in the PVZ, only light rays from partial pixels of the display panel 411 pass. Similarly, above process is applicable to other projection units. According to the geometrical structure shown in FIG. 4, two PVZs from light-restricted projection units 410 and 410′ overlap, constructing a fusing zone (FZ). To observe the projected image on the projection surface 416, the VZ-FZ zone needs to be imaged by the Field lens 430 as the viewing region.

Then, display panels 411 and 411′ are activated simultaneously to project perspective views with respect to two viewing points which locate in the two VZs' image areas, respectively. For a point in the FZ′ image area, two segments from two perspective views tile up a transitional view. When the observation point moves across the FZ′ image area, the spatial ratio of the two segments changes from 1:0 to 0:1 gradually. Consequently, a continuously changing transitional view gets realized for a moving observation point. Here, the optional diffuser 431 attached to the Field lens 430 can enlarge the emergent angle of the incident light beams, thus offering a larger viewing angle along the y-direction.

With more light-restricted projection units aligned in the display system, images of more VZs and FZs will connect, constructing a larger viewing region.

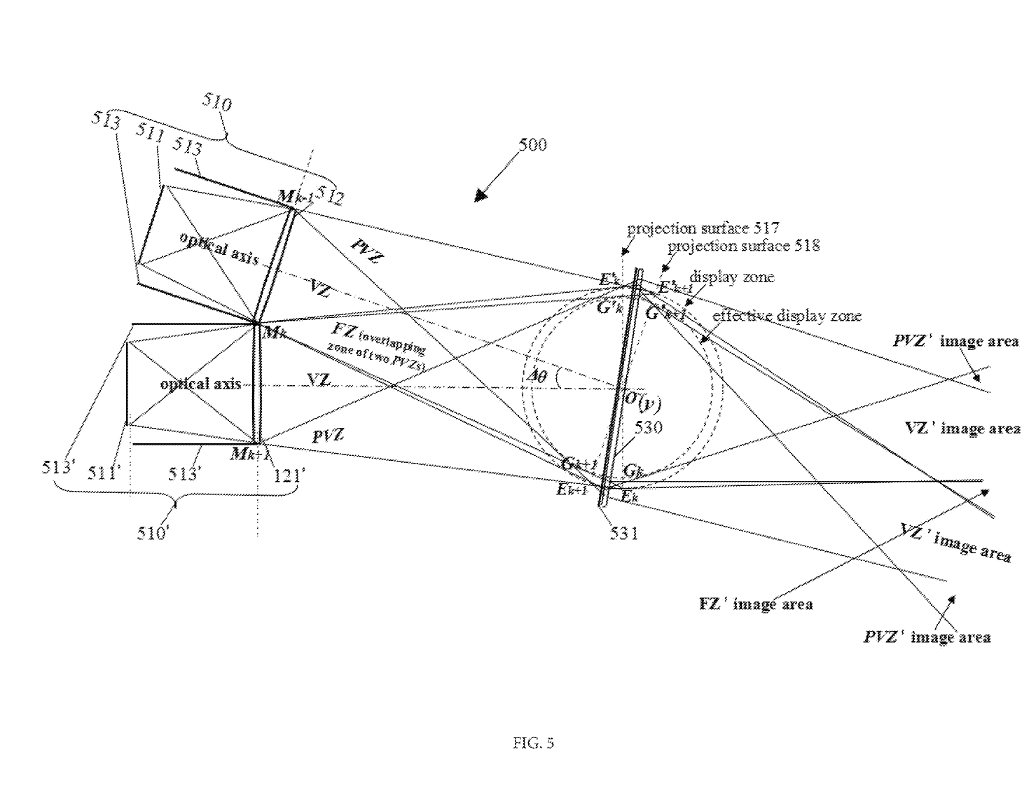

FIG. 5 shows an embodiment of a multi-view display system 500 with circular-aligned light-restricted projection units which project real images. Here, only two light-restricted projection units 510 and 510′ are drawn for simplicity, which are constituted by display panels 511 and 511′, lenses 512 and 512′ which function as the directional imaging structure, and baffles 513 and 513′, respectively. The directional imaging lenses 512 and 512′ connect at the point Mₖ, with a relative inclination angle of Δθ. Optical axises of the lenses 512 and 512′ pass through the geometrical center of the corresponding display panels 511 and 511′. Real images of the two display panels 511 and 511′ are projected to the EₖE′ₖ zone of the projection surface 517 and the Eₖ₊₁E′ₖ₊₁ zone of the projection surface 518, respectively. The EₖE′ₖ zone and the Eₖ₊₁E′ₖ₊₁ zone coexist in the common display zone centered at the point O. A Field lens 530 locates in the display zone.

When only the display panel 511 is activated, the loaded message is projected to the Eₖ₊₁E′ₖ₊₁ zone through the directional imaging lens 512. Due to the usage of baffles 513, partial light-rays from the display panel 511 which exceed the lens 512 are blocked. According to the geometric optics, the passing light-rays form two types of zones: a VZ and two PVZs. For points in the VZ, light rays from all pixels of the display panel 511 pass. But for an observation point in the PVZ, only light rays from partial pixels of the display panel 511 pass. Similarly, above processes are applicable for other projection units. According to the geometrical structure shown in FIG. 5, two PVZs corresponding to light-restricted projection units 510 and 510′ partially overlap, constructing a fusing zone (FZ). To observe the projected image on the projection surfaces 517 and 518, the VZ-FZ zone which includes all the VZs and FZs is imaged by the Field lens 530 as the viewing region. The Field lens 530 will perform imaging function on the projected message, so the presented images from light-restricted projection units 510 and 510′ need pre-correction.

Then, display panels 511 and 511′ are activated simultaneously to project two perspective views of the target object. The two perspective views converge to points belonging to the two VZs' image areas, respectively. For a point in the FZs' image area, a transitional view, tiled by two segments from different perspective views, gets observed. Similar to the situation shown in FIG. 2, for an observation point moving across the FZs' image area, the spatial ratio of the two segments changes from 1:0 to 0:1 gradually. Consequently, a continuously changing transitional view gets, realized for a moving observation point. Between the image areas of the adjacent VZ and FZ, there is a residual zone which is the image area of a partial PVZ. If Δθ is not too large, the residual zone will be covered by the pupil, and the pupil can still perceive all the messages projected from the corresponding display panels 510 or 510′. Another method is to shrink the display zone to an effective display zone determined by Gₖ, G′ₖ, Gₖ₊₁, and G′ₖ₊₁, similar to the situation of FIG. 2. Here, the optional diffuser 531 attached to the Field lens 530 can enlarge the emergent angle of the incident light beams, thus offering a larger viewing angle along the y-direction.

With more light-restricted projection units circularly-aligned in the display system, image zones of more VZs, residual PVZs and FZs will connect together, constructing a larger viewing region.

In the above embodiments, the light-restricted projection units project images directly, no matter whether they are virtual images or real images.

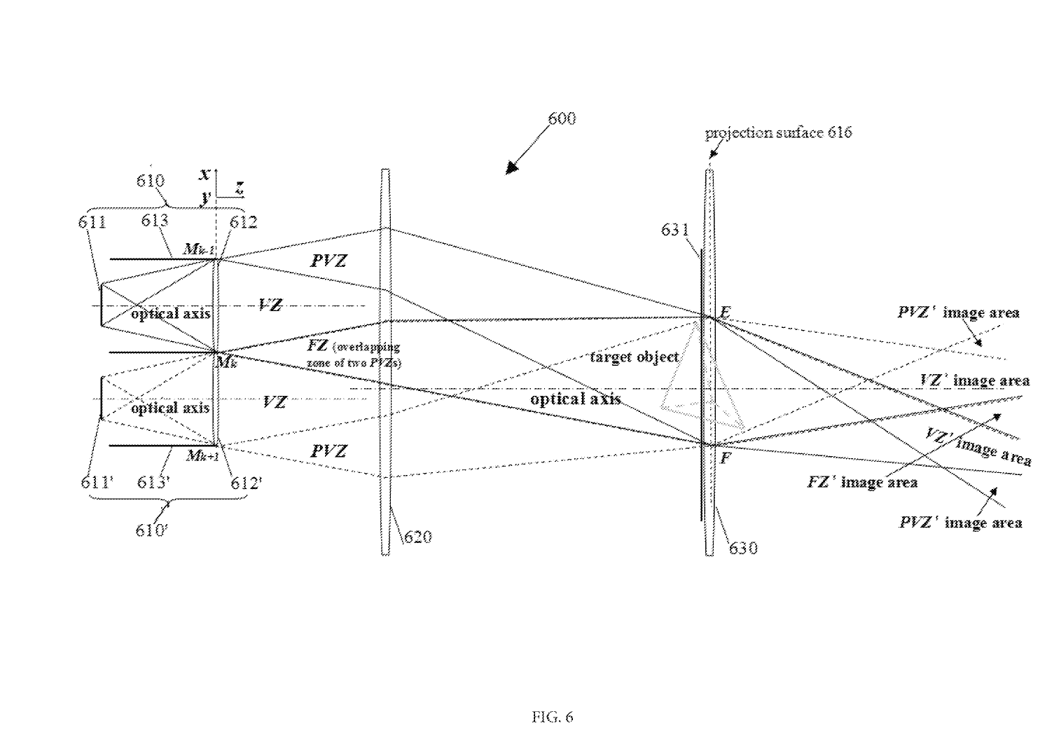

Another situation is shown in FIG. 6, an embodiment of a multi-view display system 600 employs light-restricted projection units which project images to infinity. Here, only two light-restricted projection units 610 and 610′ are drawn for simplicity, which are constituted by display panels 611 and 611′, lenses 612 and 612′ which function as the directional imaging structure, and baffles 613 and 613′, respectively. The display panels 611 and 611′ are on the front focal plane of directional imaging lenses 612 and 612′. The directional imaging lenses 612 and 612′ connect at the point Mₖ. An Accessorial Lens 620, combining with the directional imaging lens 612 and 612′, images the display panels 611 and 611′ to the common EF zone on the projection surface 616. A Field lens 630 locates on the projection surface 616.

When only the display panel 611 is activated, the loaded messages are projected to the EF zone through the directional imaging lens 612 and the Accessorial Lens 620. Due to the usage of baffles 613, partial light-rays from the display panel 611 which exceed the lens 612 are blocked. According to the geometric optics, the passing light-rays form two types of zones: a VZ and two PVZs. For points in the VZ, the light rays from all pixels of the display panel 611 pass. But for a point in the PVZ, only light rays from partial pixels of the display panel 611 pass. Similarly, above processes are applicable to other projection units. According to the geometrical structure shown in FIG. 6, two PVZs from light-restricted projection units 610 and 610′ overlap, constructing a fusing zone (FZ). To observe the projected image on the projection surface 616, the VZ-FZ zone is imaged by the Accessorial Lens 620 and the Field lens 630 as the viewing region.

Then, display panels 611 and 611′ are activated simultaneously to project perspective views which converge to points belonging two VZs' image areas, respectively. For a point in the FZs' image area, two segments from two perspective views tile up a transitional view. When the observation point moves across the FZs' image area, the spatial ratio of the two segments changes from 1:0 to 0:1 gradually. Consequently, a continuously changing transitional view gets realized for a moving observation point. Here, an optional diffuser 631 attached to the Field lens 630 can enlarge the emergent angle of the incident light beams, thus offering a larger viewing angle along the y-direction.

With more light-restricted projection units involved in the display system, image areas of more VZs and FZs will connect together, constructing a larger viewing region.

In the above discussion about FIG. 6, if the real image area of the VZ-FZ zone can be formed through only the Accessorial Lens 620, the Field lens 630 will not be necessary.

In the FIG. 6, the Accessorial Lens 620 is designed to generate real images of the display panels 611 and 611′. Actually, when the Accessorial Lens 620 is designed to image the display panels 611 and 611′ as virtual image, the system works as a multi-view display based on a similar theory, but the Field lens 630 and the optional diffuser 631 will not be needed anymore.

In all above embodiments, a gating-aperture array can be introduced into the VZ-FZ zone which includes all the VZs and FZs, or the image area of the VZ-FZ, for presenting perspective views to more points with the time-multiplexing technique.

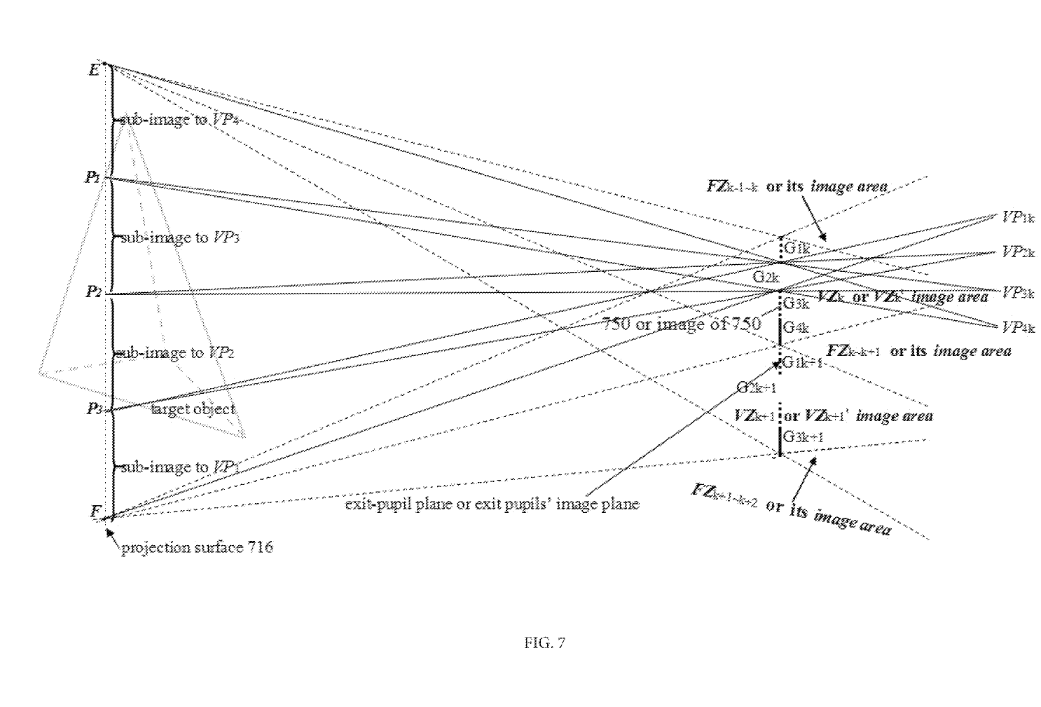

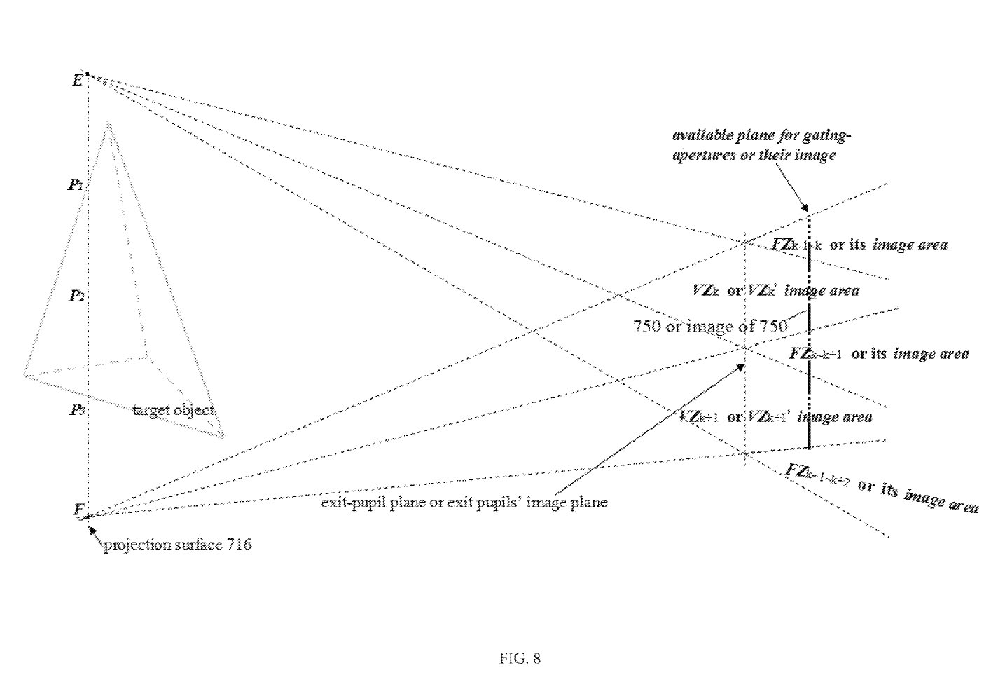

FIG. 7 explains a time-multiplexing method based on a gating-apertures array 750, with clear apertures of all gating apertures aligned seamlessly. Here, light-restricted projection units are planar-aligned, with the EF zone on the projection surface 716 used as the overlapping zone of all images projected from different light-restricted projection units. Only two VZs (VZₖ and VZₖ₊₁ form light-restricted projection unit k and k+1) and three FZs (VZ_{k-1˜k}, VZ_{k˜k+1} and VZ_{k+1˜k+2}), or their image areas, are drawn in FIG. 7 for simplicity. The gating apertures are close to (or on) the exit pupil plane (or the exit pupil's image plane) of the directional imaging structure. Here, four gating apertures for one light-restricted projection unit are taken as an example, which are denoted as G₁ₖ, G₂ₖ, G₃ₖ, G₄ₖ, G₁ₖ₊₁, G₂ₖ₊₁, G₃ₖ₊₁, and G₄ₖ₊₁. The former subscript denotes the serial number of the gating apertures and the latter subscript denotes the serial number of the corresponding projection unit. When a gating aperture is opened, for example G₂ₖ, four sub-images projected from the light-restricted projection unit k are presented to four points VP₁ₖ, VP₂ₖ, VP₃ₖ, and VP₄ₖ, respectively. Perspective views converging to VP₁ₖ or a nearby point, to VP₂ₖ or a nearby point, to VP₃ₖ or a nearby point, and to VP₄ₖ or a nearby point are set to be the contents of the corresponding four sub-images. The image tiled up by the four sub-images will be the projection content from the projection unit k when G₂ₖ gets opened. Repeat this process for each gating aperture to obtain all the needed projection contents. At a time point, one group of gating apertures, e.g. G₂ₖ and G₂ₖ₊₁, are gated with all the display panels refreshed for projecting the corresponding projection contents. Then different groups of gating apertures are gated sequentially and cyclically, with all display panels refreshed for projecting corresponding projection contents synchronously. When the cycle time is small enough, a multi-view display based on persistence of vision will get implemented. Especially, when the interval between adjacent viewing points is smaller than the pupil of the viewer, two or more perspective views will be perceived by one pupil and a super-multi-view display comes into truth. The gating apertures can also be placed away from the exit pupil (or the exit pupil's image plane) of the directional imaging structure, as shown in FIG. 8. In this architecture, some gating apertures will enter into FZs. When such gating apertures get opened, the corresponding sub-image images will be projected from different light-restricted projection units.

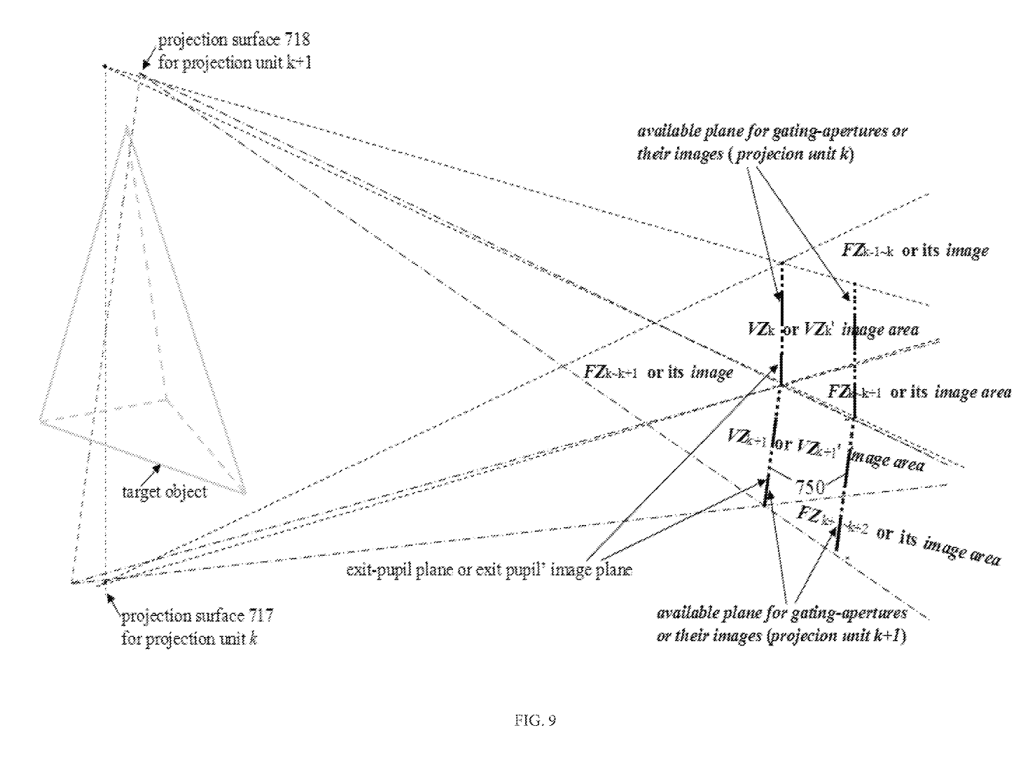

In the above discussion about FIG. 7, we suppose that exit pupils of all light-restricted projection units coincide on a plane. Actually, the described time-multiplexing can be applied to above mentioned embodiments with circular-aligned light-restricted projection units, which need circular-aligned exit pupils of different directional imaging structures. In this architecture, the gating apertures corresponding to each projection unit may be aligned parallel with the exit pupil plane or the exit pupil's image plane of this light-restricted projection unit, as shown in FIG. 9, as an example.

In the above discussed FIG. 7, FIG. 8 and FIG. 9, the gating apertures can be replaced with gating apertures with small clear apertures. In this case, the clear apertures of adjacent gating apertures will not be seamlessly aligned. When a gating aperture is gated, the perspective view converging to a point on or near this aperture or its image is taken as the target image projected from the corresponding one or more display panels. In a special case that no gating apertures enter into the FV zones, the existing of the FZs is not necessary for the invention. In this case, the baffles can extend into the PVZs of each light-restricted projection unit. Consequently, the FZ zones will shrink or even disappear.

In all above discussions, the observing point of the viewer is often set not to be far away from the display zone. In this case, for a point in a FZ or its image area, the observed perspective view is tiled up by two segments from adjacent projection units. Actually, when the observation point is far from the display zone, the observed perspective view will be tiled up by three or more segments projected from different display panels.

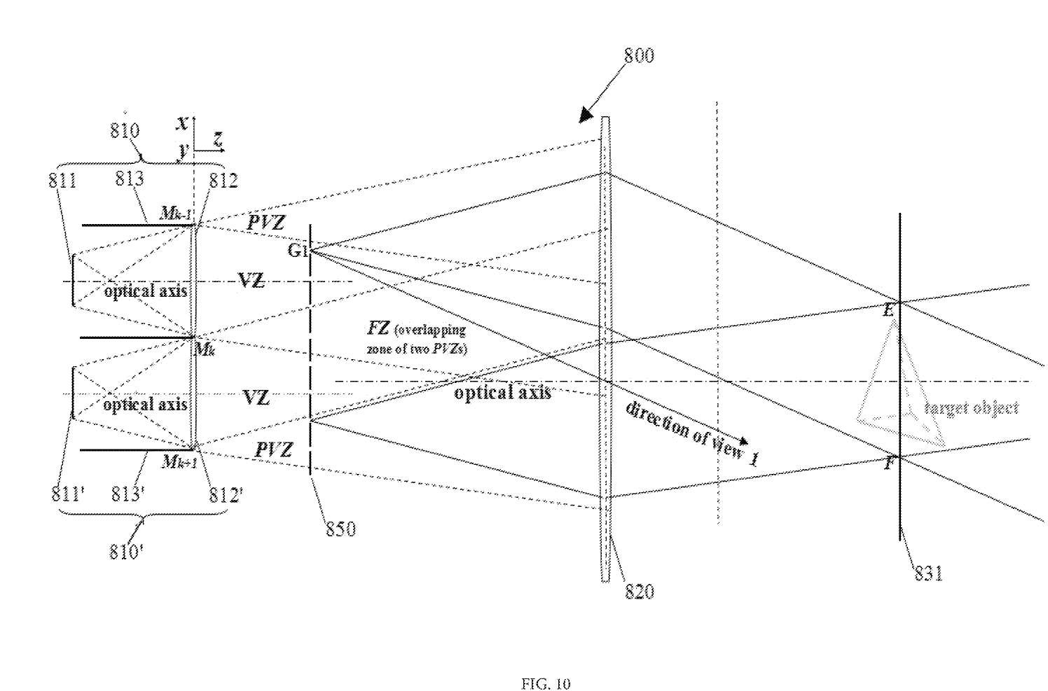

When the viewpoint of the projected perspective view is set at infinity, the image projected from each projection unit will be an orthogonal view. FIG. 10 is an embodiment of a time-multiplexing multi-view display system 800 with planar-aligned light-restricted projection units which project orthogonal images. Only two light-restricted projection units 810 and 810′ which are constituted by display panels 811 and 811′, lenses 812 and 812′ functioning as the directional imaging structure, and baffles 813 and 813′, respectively, are drawn for simplicity. The display panels 811 and 811′ are on the front focal plane of the corresponding directional imaging lenses 812 and 812′. A gating-aperture array 850 is placed on the focal plane of the directional imaging lenses 812 and 812′. The directional imaging lenses 812 and 812′ connect at the point Mₖ. An Accessorial Lens 820 has a distance of its focal length away from the gating-aperture array 850. When a gating aperture is opened, for example G₁, an orthogonal view along the direction of view 1 is projected. The direction of view 1 is along the line connecting a point on the G₁ (often the center point of the G₁) and the optical center of the Accessorial Lens 820. When the G₁ is in a VZ, the orthogonal view is projected from one display panel 811. But when the G₁ is in a FZ, the orthogonal view will be projected from two segments belonging to display panels 811 and 811′, respectively. Repeat this process for each gating aperture to obtain all the needed orthogonal messages. At a time point, one group of gating apertures are gated with display panels refreshed for projecting the corresponding orthogonal views. Then different groups of gating apertures are gated sequentially and cyclically, with display panels refreshed for projecting the corresponding orthogonal views synchronously. When the cycle time is small enough, a multi-view display based on persistence of vision will get implemented. The optional diffuser 831 locates on the focal plane of the Accessorial Lens 820 to enlarge the emergent angle of the incident light beams, thus offering a larger viewing angle along the y-direction. Here, if the Accessorial Lens 820 is designed to image the display panels 811 and 811′ as virtual images, the system works as a multi-view display based on a similar theory, but the optional diffuser 831 is not needed anymore.

In the above embodiments, a display with small size and large diverging angle can work as the display panel. Examples of such devices include OLED displays, or LED displays, or a liquid crystal display, or a Digital Light Processing (DMD).

A number of embodiments of the invention have been described. Nevertheless, it will be understood that various modifications may be made without departing from the spirit and scope of the invention. For example, the optical components used to image the display panels or VZ-FZ zone are not limited to those described above. Any combination of lenses, prisms, diffractive and holographic optical elements, or other light-controlling component may be used for this purpose. Accordingly, other embodiments are within the scope of the following claims.

What is claimed:

1. A system comprising:
light-restricted projection units, each unit being constituted by a display panel displaying optical images, a directional imaging structure transmitting optical messages from the display panel along a specific direction, and baffles encasing the display panel/directional imaging structure pair for light blocking; and
an optional Accessorial Lens;
wherein each pixel of the display panel has a diverging angle which is large enough to cover the corresponding directional imaging structure; during operation, display panels are imaged to a common display zone through the corresponding directional imaging structures or the combination of the corresponding directional imaging structures and the Accessorial Lens; with baffles blocking partial light rays emitting from the display panels, for each light-restricted projection unit, two types of zones are generated subsequently:
1) VZ where the light rays from all the pixels of the display panel pass and
2) PVZ where only light rays from partial pixels of the display panel pass;
light-restricted projection units are aligned in planar or curved ways, the PVZs from different light-restricted projection units overlap completely or partially into a fusing zone (FZ); for each point in the FZ, light rays from pixels belonging to segments of different display panels pass.

2. The system of claim 1, wherein the display panel can be an Organic Light-Emitting Diode (OLED) display, a LED display, a liquid crystal display, or a Digital Light Processing (DMD).

3. The system of claim 1, wherein the directional imaging structure is a lens or a group of optical elements functioning as a lens.

4. The system of claim 1, wherein the directional imaging structure is a lens-prism pair.

5. The system of claim 1, wherein the directional imaging structure is a diffraction grating, or a diffraction grating-lens pair.

6. The system of claim 1, further comprising a Field Lens which images the VZs and FZs.

7. The system of claim 1, further comprising a diffuser which enlarges the scattering angle of the incident light.

8. The system of claim 6, further comprising a diffuser which enlarges the scattering angle of the incident light.

9. The system of claim 1, further comprising a gating-aperture array whose gating apertures are gated sequentially.

10. The system of claim 6, further comprising a gating-aperture array whose gating apertures are gated sequentially.

11. The system of claim 7, further comprising, a gating-aperture array whose gating-apertures are gated sequentially.

12. The system of claim 8, further comprising a gating-apertures array whose gating apertures are gated sequentially.

13. A method, comprising:
projecting a perspective view which converges to a point from a display panel or segments of different display panels through the corresponding directional imaging structures; and
presenting perspective views which converge to different points simultaneously.

14. The method of claim 13 wherein a perspective view is projected from a display panel or segments of different display panels through the corresponding directional imaging structures and an Accessorial Lens.

15. The method of claim 13 wherein a perspective view is projected from a display panel or segments of different display panels through the corresponding directional imaging structures and a Field Lens.

16. The method of claim 13 wherein a perspective view is projected from a display panel or segments of different display panels through the corresponding directional imaging structures, an Accessorial Lens and a Field Lens.

17. A method, comprising:
inserting a gating-aperture array into the VZ-FZ zone which includes all the VZs and FZs; with a gating-aperture being gated, sub-images projected from one or more display panels through the corresponding optical structures get presented to different points, each such sub-image is set to carry the content of the perspective view converging to the corresponding point or a point near the corresponding point;
gating a group of gating-apertures at one time point, with all display panels refreshed for generating corresponding sub-images; and
gating different groups of gating-apertures sequentially and cyclically, with all display panels refreshed synchronously for generating the corresponding sub-images.

18. The method of claim 17 wherein a gating-aperture array is inserted into the image area of the VZ-FZ zone which includes all the VZs and FZs.

19. A method, comprising:
inserting a gating-apertures array into the VZ-FZ zone which includes all the VZs and FZs; with a gating-aperture being gated, the perspective view converging to a point on or near this gating-aperture is taken as the target image projected from one or more display panels through the corresponding optical structure;
gating a group of gating-apertures at one time point, with display panels refreshed for generating corresponding target images; and
gating different groups of gating-apertures sequentially and cyclically, with all display panels refreshed synchronously for generating corresponding target images.

20. The method of claim 19 wherein, when a gating-aperture is gated, the perspective view converging to a point on or near this gating-aperture's image area is taken as the target image projected from one or more display panels through the corresponding optical structure.

21. The method of claim 19 wherein a gating-aperture array is inserted into the image area of the VZ-FZ zone which includes all the VZs and FZs.
